(19) United States
(12) Patent Application Publication
(10) Pub. No.: US 2012/0310436 A1
(43) Pub. Date: Dec. 6, 2012

(54) METHOD OF OPERATING A MAXIMUM POWER POINT TRACKER

(75) Inventor: Soren Baekhoj Kjaer, Harrislee (DE)

(73) Assignee: Danfoss Solar Inverters A/S, Soenderborg (DK)

(21) Appl. No.: 13/577,081

(22) PCT Filed: Feb. 11, 2011
(86) PCT No.: PCT/DK2011/000006

§ 371 Date: Aug. 3, 2012

(30) Foreign Application Priority Data
Feb. 16, 2010 (DK) PA 2010 00131

(51) Int. Cl. G06F 1/26

(52) U.S. Cl. 700/297

(57) ABSTRACT

The present invention relates to a method of operating a maximum power point tracker comprising the steps of performing a sweep cycle at intervals, the sweep cycle comprising the determination of at least one first parameter of a power function, storing the at least one first parameter and at least one second parameter and, based on the data so stored, modifying one or more characteristics of the sweep cycles. The invention also relates to a maximum power point tracking apparatus comprising a controller (12, 115) suitable for controlling an operating parameter, an input (4, 104) connected to a power source (3, 103) and a data store (15, 115), which apparatus is suitable for being operated by the above method.

### CROSS REFERENCE TO RELATED APPLICATIONS

This application is entitled to the benefit of and incorporates by reference essential subject matter disclosed in International Patent Application No. PCT/DK2011/000006 filed on Feb. 11, 2011 and Danish Patent Application No. PA 2010 00131 filed Feb. 16, 2010.

### TECHNICAL FIELD

The present invention relates to a method and apparatus for tracking the maximum power point of a power source.

### BACKGROUND

The generation of electrical power can be accomplished from a number of different sources. Whilst some sources, such as traditional coal or oil-fired power stations or a petrol driven generator, have stable, known characteristics and so efficient conversion of their output into a useable form is predictable, other sources, such as solar or wind power, present additional problems which can influence the efficiency of conversion. This is because the ‘operating point’ of such sources, that is to say the way in which they are controlled so as to extract the maximum power from them, is highly dependent upon external conditions such as the intensity of solar radiation or wind.

Often this problem is solved by the use of an electrical converter such as an inverter, which presents to the energy source an electrical load which is optimal for efficient conversion. Electrical converters often continually adjust their input characteristics so as to continually present the optimal load in the face of changing source characteristics brought about by changes in, for example, solar energy or wind.

In a typical application an energy source will act as a generator supplying either a DC current against a control voltage, or a DC voltage against a control current. FIG. 6 illustrates a typical current 132 generated against control voltage for such an energy source (such as a photovoltaic array in sunlight). A similar function is also obtained for voltage generated against a control current, since often either current or voltage can be the variable controlled. FIG. 7 illustrates the power function 131 for such a source, power being calculated by the product of the control voltage and the current flowing. This power function has a maximum which is often referred to as the maximum power point 130 (MPP).

In order to extract the maximum power, then the control variable (for example the voltage or current) should be managed in a way in which it keeps the operating point of the source as close as possible to the maximum, despite the fact that external conditions will change the value of the control variable at which this occurs. The apparatus which accomplishes this is known as maximum power point tracker (MPPT).

FIGS. 6 and 7 also illustrate the effect of changing external conditions on the output characteristics. FIG. 6 shows three i-V functions 132, 133, 134 corresponding to three different sets of external conditions. In the case of a photovoltaic array these may be due to the amount of radiation reaching the array. The corresponding P-V functions for these three cases are shown by 135, 136 and 137 in FIG. 7. We can see from FIG. 7 that the value of the control voltage yielding the MPP changes (from the voltages 138 to 139 and then to 140) as these external conditions change. The MPPT tracks these changes in a continuous or semi-continuous manner; following the power peak as it changes with time by constantly checking if the control voltage lies at a local maximum in the P-V function.

Such a system is well known in the art.

There are some situations in which an MPPT may fail to return the true maximum power point. These are situations in which the power function relative to the control variable has more than one peak. This is illustrated in FIG. 8, where three peaks 141, 142 and 143 are shown. The peak with the relative maximum is known as a global maximum. In the case of a photovoltaic array this may occur if part of the array is in shadow. It is possible that the development of the multi-peaked function of FIG. 8 may occur in a way that the MPPT ends up tracking the peak at 141 or 143 rather than the global maximum at 142. In this situation, the power developed by the electrical converter is less that the maximum possible, resulting in reduced efficiency.

A known way of avoiding this situation is to interrupt normal operation in order to run a routine which plots the power function within the extreme limits of the control variable, or within some portion of the range of the control variable. After this has been done, the global maximum can be found and the MPPT system is located on this, and will continue to track this peak. This method for locating the global maximum is often known as a ‘sweep’ or a ‘scan’. Whilst such a procedure will ensure that the peak power is available, there are distinct disadvantages is running the procedure too often. These disadvantages include the fact that during the period that the sweep is being conducted, the power available for conversion is on average below the peak available from the source. Whilst the sweep can be conducted speedily, this will in general result in less accurate results.

### SUMMARY

Therefore, it is an object of the invention to provide a maximum power point tracker and a corresponding method of operating such a maximum power point tracker with an efficiency better than maximum power point trackers known to the art.

It is a further object of the invention to provide a maximum power point tracker and a corresponding method of operating such a maximum power point tracker which is capable of supplying power more continuously and at a higher level than maximum power point trackers known to the art.

According to the invention in a first aspect, the above and other objects of the invention are achieved by providing a method of operating a maximum power point tracker comprising the following steps: performing a sweep cycle at intervals, storing the at least one peak-related parameter and at least one time parameter and, based on the data so stored, modifying one or more characteristics of the sweep cycles.

Here, by the term ‘sweep cycle’ is to be understood a sequence comprising the determination of at least one peak-related parameter of a power function, the power function being, for example, that of a power source which the maximum power point tracker is connected to. By ‘power function’ is to be understood the relationship between the power available from the power source and some other parameter. In addition, the term ‘peak-related parameter’ may be a number which characterises the power function. This might be, for example, the peak power or the number of peaks in the function. Alternatively or additionally the peak-related parameter might be a “Peak Ratio” function, described in more detail below, which is a convenient measure of presence and effect of one or more peaks in the power function. The at least two parameters may be stored as a set of parameters for later analysis. By the term ‘based on the data’ it may be understood that an analysis may be made of the stored data and, depending upon the results of such an analysis, one or more characteristics of the sweep cycles may be changed.

The modification of one or more characteristics of the sweep cycles according to the first aspect of the present invention may further be dependent upon at least one correlation between the stored peak-related parameters and time parameters. By correlation may be understood the probabilistic dependence between the two sets of data.

The time parameter according to the first aspect of the present invention may be measured in connection with the sweep cycle. That is to say, it may be measured at the same time, just before or just after performing the sweep cycle. This may be, for example, the time at which the sweep cycle was performed, or the time of day (that is to say, the time elapsed since the start of the day) at which the sweep cycle was performed.

The maximum power point tracker, according to the first aspect of the present invention, may control an operating parameter. This may, for example, be an operating parameter of the power source. This operating parameter may be a voltage. Alternatively it may be a current.

The characteristics of the sweep cycles may comprise one or more of the following; the intervals between each sweep cycle, the range of operating parameter that a sweep cycle covers or the speed at which a sweep cycle is performed.

The power function itself may further comprises the relationship between the power available from the power source and the operating parameter.

In one embodiment the at least one first parameter may comprise the number of peaks in the power function, or alternatively or additionally it may comprise a function of the Peak Ratio calculated for the power function. By “Peak Ratio” in this context is meant a function based on the ratio of each individual local peak to the global peak for a given power function. Examples of such a Peak Ration are described herein under.

In one embodiment the operating parameter which is controlled by the maximum power point tracker may be a voltage or a current.

The modification according to the first aspect of the present invention may further comprise limiting the performance of sweep cycles substantially to times of day when the power function shows more than one peak. The choice of such times of day can be made based on a correlation shown between the presence of multiple peaks in the power function and the time of day. In this way sweep cycles may be made less often at times of day when no multiple peaks have been seen, and so the overall efficiency of the maximum power point tracker may be much improved.

In a second aspect, the invention relates to a maximum power point tracking apparatus comprising a controller suitable for controlling an operating parameter, an input connected to a power source and a data store, which apparatus is suitable for being operated by the method as described above, or in the claims section.

Here the controller may be a circuit suitable for changing the operating parameter such as one based on a microprocessor, microcomputer, FPGA or other suitable electronic component, and may be programmable. The data store may be an electronic storage device such as a hard disk or floppy disk, volatile or non-volatile memory devices, or any other device where data may be stored in and later recovered from.

In a preferred embodiment the operating parameter may be a voltage. Alternatively, the operating parameter may be a current.

The power source according to the second aspect of the present invention may comprise one of one or more photovoltaic strings, photovoltaic arrays, wind motors, fuel cells or hydroelectric generators.

### BRIEF DESCRIPTION OF THE DRAWINGS

The present invention and its advantages will become more apparent, when looking at the following description of possible embodiments of the invention, which will be described with reference to the accompanying figures, wherein

FIG. 1 shows a power converter system which comprises a maximum power point tracker according to a first embodiment of the present invention;

FIG. 2 shows a power converter system which comprises a maximum power point tracker according to a second or third embodiment of the present invention;

FIG. 3 shows an illustration of the control voltage from a particular photovoltaic array in the northern hemisphere versus time over a period from before sunrise to after sunset on a particular day, and controlled by a prior art maximum power point tracker;

FIG. 4 shows a flowchart of the method according to a third embodiment of the present invention;

FIG. 5 shows a histogram of the typical contents of the data store according to a third embodiment of the present invention when the photovoltaic array shown in FIG. 3 is used as a power source;

FIG. 6 shows an illustration of a typical current generated against control voltage for an energy source;

FIG. 7 shows an illustration of the power function for the source illustrated in FIG. 6; and

FIG. 8 shows an illustration of a power function that has more than one peak.

### DETAILED DESCRIPTION

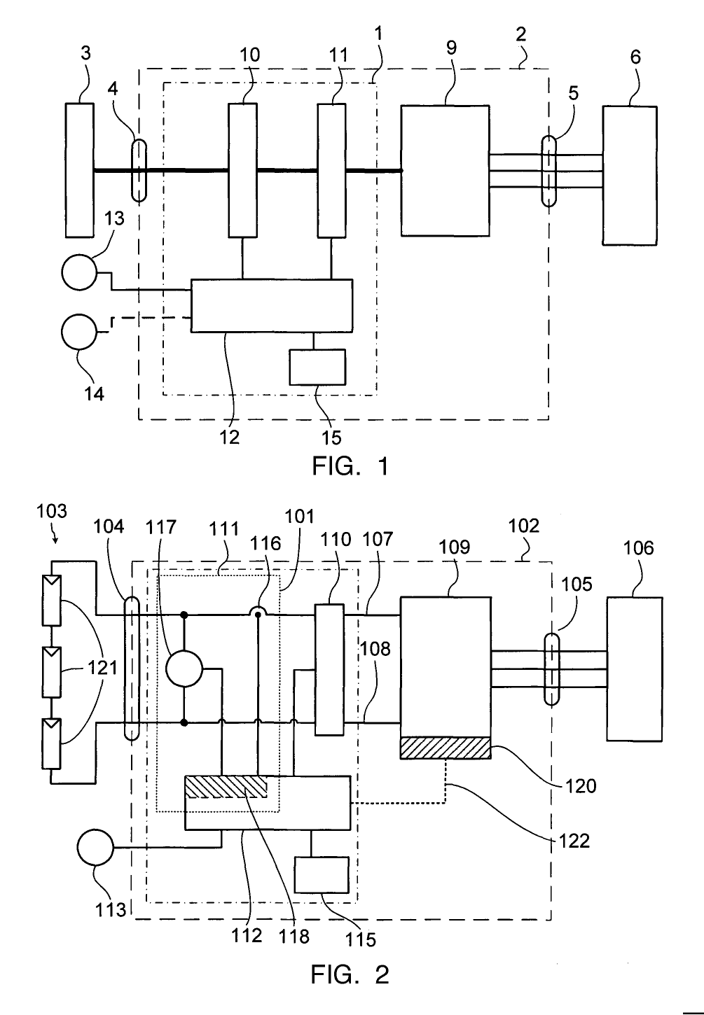

FIG. 1 shows a schematic diagram on a first embodiment of the invention. Illustrated here is an electrical power converter 2 which is connected to a power source 3 via an input connection 4 and outputs power through output connections 5 in a suitable form for a load 6. The load 6 may comprise an electrical apparatus such as a motor or battery, or a network such as an electrical distribution net of one or more individual phases. The output connections 5 are suitable for the form of output (for example one or more phases). The power source 3 provides a supply to the input 4 and the electrical power converter 2 shown here comprises an output converter 9, which converts the power from the input 4 to a form suitable for the outputs 5, and a maximum power point tracker (MPPT) 1. The MPPT 1 in turn comprises an operating parameter setter 10 and a power measuring system 11. The setter 10 is controlled by a controller 12 which receives inputs from the power measuring system 11 and one or more additional sensors 13, 14. Also available to the controller 12 is a data store 15 suitable for writing into data into or reading data from.

In one version of this embodiment the power source 3 provides a DC supply. In another version of this embodiment the power source 3 provides an AC supply.

The positions of the operating parameter setter 10 and the power measuring system 11 may be reversed, the power measuring system 11 being adjacent to the input 4. The power measuring system 11 may, alternatively, be placed between the output power converter 9 and the output connections 5.

The power source 3 produces power as a function of a number of parameters, including the value of the operating parameter set by the setter 10 and a number of external parameters. To take the example where the power source 3 comprises a photovoltaic array, these external parameter might well include, amongst others, the elevation of the sun, the presence of clouds or shadows at the array, the temperature, age or cleanliness of the array. In order to assist the function of the MPPT1, it also is supplied with data from sensors 13 and 14 (or more) which supply information on one or more of these external parameters.

The method of operation of this apparatus is as follows:

The controller 12 can operate in two modes, tracking and sweep cycle. During normal operation it runs in tracking mode, where it controls the setter 10 so that the operating parameter is kept close to the maximum power point value of the operating value. As the maximum power point of the source 3 changes, the controller 12 follows this change by use of the power measuring system 11. This mode is often sufficient for following the global maximum power point, however, under certain circumstances, it may fail. For example, if the characteristic function of the power vs. operating parameter changes to a function containing more than one peak in a way in which the tracking mode ends up following a local maximum power point which is no longer the global maximum power point.

In order to correct this, the controller is also able to operate in a sweep cycle mode which may comprise the following steps:
a) Stop the tracking mode of operation.
b) Set the operating parameter to a first value using the setter 10.
c) Measuring the power generated by the power source using the power measuring system 11.
d) Repeat steps b) and c) with a different value of the operating parameter until sufficient measurements of the power generated by the power source have been made in a selected range of the operating parameter to enable the identification of the global maximum power point within the selected range.
e) Analyse the set of power measurements made in steps b) to d) to identify the value of the operating parameter which corresponds to the global maximum power point. It is clear that the more measurements are made, and the closer they are spaced in terms of the operating parameter, the more accurate the estimate of the global maximum power point will be.
f) Store in the data store 15 one or more values derived from the set of power measurements made in steps b) to d). These values may comprise the global maximum power point identified in step e) but may alternatively comprise the number of peaks in the power vs. operating parameter function, the power values of those peaks, or other data.
g) Store in the data store 15 additional parameters derived from the one or more sensors 13, 14. These data may comprise the time or time of day at which the sweep cycle was performed, the temperature of the air, fuel, electronics or equipment, the strength, direction or gustiness of the wind, or any other parameter that may be appropriate.
h) Recommence the tracking mode of operation with the initial value of the operational parameter set to the global maximum power point value identified in step e).

When the power converter 2 is initially commissioned, it may perform a sweep cycle at regular intervals. Such intervals may, for example, be once every hour, or once every 5 minutes, whatever is most appropriate for the application in which the power converter is utilised, and/or the form of power source 3 which is in use. Gradually, a store of data will be accumulated comprising sets of data resulting from individual sweeps. At a predetermined time after start-up, or after a predetermined number of sweep cycles have been performed, or in response to some other parameter, an analysis of the stored data is performed. This analysis detects correlations between data held in the store 15. By correlation is meant a statistical dependence between two variable or two combinations of variables.

In particular in the embodiment illustrated in FIG. 1, the correlations detected are between the data stored in step f) of the above method and the data stored in step g). In one version of this embodiment this may be a correlation between the presence of multiple peaks in the power vs. operating parameter function derived from the set of power measurements made during a sweep cycle, and the time of day at which those measurements were made, the time of day being one of the additional parameters stored in step g) of the above method.

Turning now to FIG. 2 we find a schematic diagram of a second embodiment of the present invention. Here a MPPT 101 forms part of a power converter 102 suitable for converting the power supplied by a photovoltaic array 103 and connected to the input 104 to a three phase supply at the output 105 which is fed into a public power grid network 106. The photovoltaic array in this embodiment is made up of three series-connected photovoltaic modules 121. The power is supplied in the form of a DC current and the operating voltage of the input is set by the setter 110. Measurements of the voltage and current at the input 104 are made by the voltmeter 117 and ammeter 116 respectively. The measurements are supplied to the controller 112 which comprises a power calculator 118, using the inputs from the voltmeter 117 and ammeter 116. The power calculator may additionally or alternatively calculate a power derivative, for example dp/du or dp/di. An inverter 109, controlled by an inverter controller 120 converts the DC appearing on the DC link 107, 108 to a three phase signal with appropriate characteristics for feeding into the network 106. The controller 112 stores and reads data from a data store 115, and a clock 113 supplies time information.

An alternative system to the setter 110 for controlling the voltage seen at the input 104 is to control the inverter directly so that the voltage seen at the input of the inverter 109 is controlled appropriately. A control line 122 is therefore shown to accomplish this task.

As described in the first embodiment, the controller 112 can operate in two modes, tracking and sweep cycle. During normal operation it runs in tracking mode, where it controls the setter 110 so that the voltage at the input 104 (Vi) is kept close to the maximum power point value of the operating value. As the maximum power point of the source 103 changes, the controller 12 follows this change.

In order to correct this, the controller is also able to operate in a sweep cycle mode in which may comprise the following steps:
a) Stop the tracking mode of operation.
b) Set Vi to a first value using the setter 110.
c) Measure the power generated by the power source using the power measuring system 111.
d) Repeat steps b) and c) with a different value of Vi until sufficient measurements of the power generated by the power source have been made in a selected range of Vi to enable the identification of the global maximum power point within the selected range.
e) Analyse the set of power measurements made in steps b) to d) to identify the value of Vi which corresponds to the global maximum power point.
f) Store in the data store 115 the number of peaks in the power vs. Vi function obtained from set of power measurements made in steps b) to d).
g) Store in the data store 115 the time at which the sweep was performed, obtaining this data from the clock 113.
h) Recommence the tracking mode of operation with the initial value of Vi set to the global maximum power point value identified in step e).

On start-up, the MPPT 101 performs a sweep cycle at regular intervals. Such intervals may, for example, be once every hour, or once every 5 minutes. Gradually, a store of data will be accumulated comprising the number of peaks in the power vs. Vi function obtained from each individual sweep cycle performed, and the times at which those sweep cycles were performed. At a predetermined time after start-up, or after a predetermined number of sweep cycles have been performed, or in response to some other parameter, an analysis of the stored data is performed. This analysis detects correlations between the time of day (for example, the elapsed time since midnight) and the presence of multiple peaks in the power function. In the case of a photovoltaic array this is of particular interest, since multi-peaked power functions occurring at around the same time of day are very likely to be caused by partial shadowing of a photovoltaic array 103.

Once it has been established in this way the time of day at which shadowing occurs, then the operation of the MPPT 101 is modified so that it preferentially performs sweeps cycles as these times of day. In this way the efficiency of the system is much improved, since fewer sweeps cycles will now be performed and so the loss of power outputted to the grid 106 will be reduced. That is to say, sweep cycles will only be performed when, from historical data, it is likely that shadowing of the photovoltaic array 103 is occurring.

Since seasonal variations in solar altitude will also influence the time at which shadowing occurs, it will still be an advantage to perform sweep cycles at other times of day, in order to keep the statistics up to date.

Thus, to summarise, in this embodiment sweep cycles are performed at regular intervals until sufficient have been performed to recognise the pattern in the presence of multi-peaked power function (indicative of the presence of partial or full shadowing of the photovoltaic array). The performance of further sweep cycles are then restricted to
1) times of day known to be subject to shadowing and
2) other times of day, but at a lower rate than in the start-up phase, in order to monitor the changing pattern of shadowing.

A third embodiment of the invention will now be described. This embodiment can also be described by the schematic diagram shown in FIG. 2, wherein the power converter 102 is supplied with power from a photovoltaic array 103 subject to possible shadowing. The method used in this embodiment for determining how often it is necessary to perform a sweep cycle (performed as described above) in order to detect shadows is described below.

A sweep cycle could be performed once every second, but during a sweep cycle the power available at the output connections 105 of the converter 102 is severely limited, perhaps only an average of 60% of the power available at that time from the photovoltaic array 103 is available at the output of the converter, and so performing a sweep cycle reduces the overall energy outcome, as is well known in the art. On the other hand, sweeping once per hour might be too seldom to discover and track the shadows which fall across the photovoltaic array.

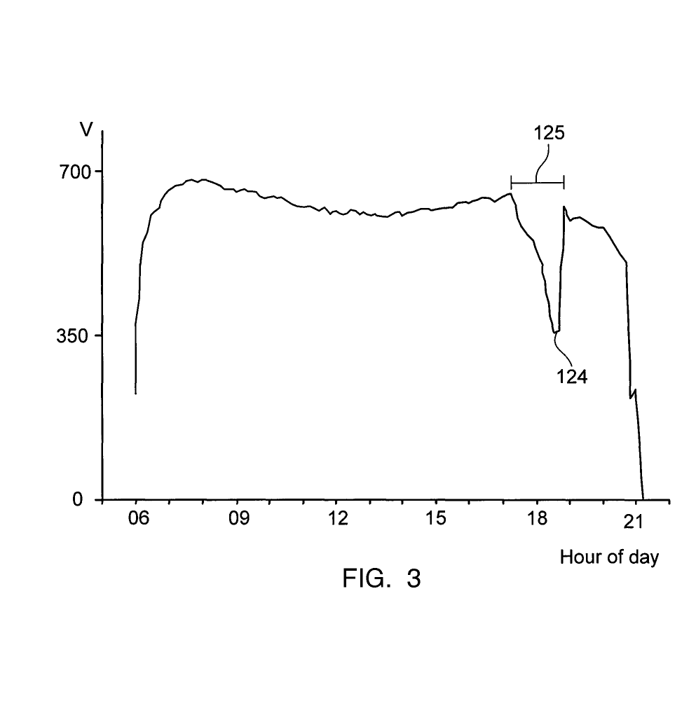

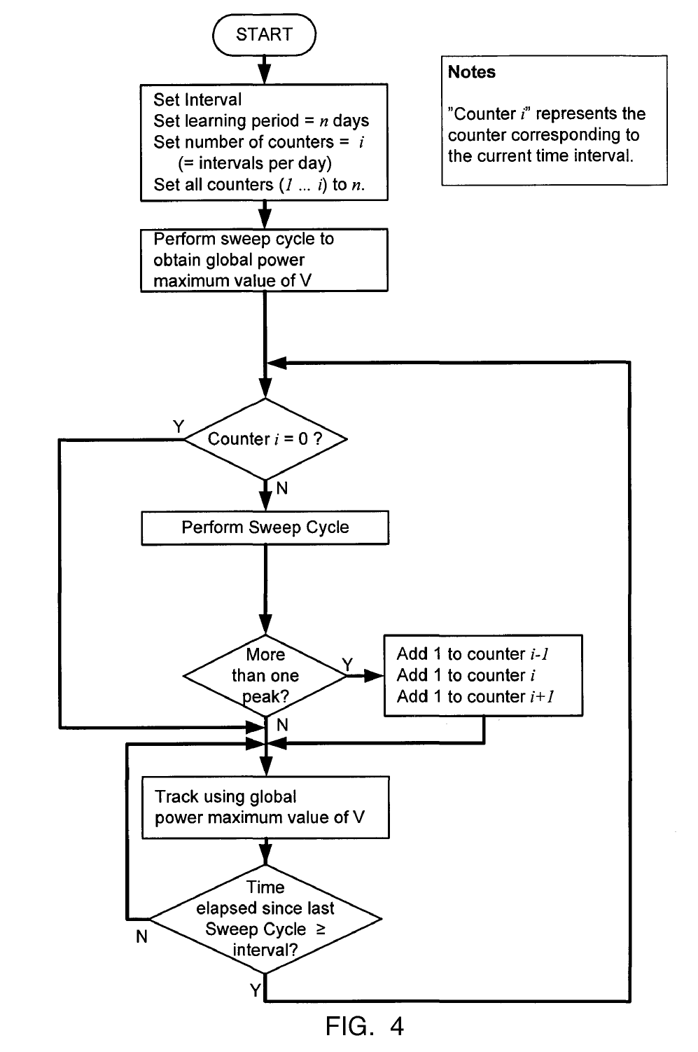

FIG. 3 illustrates the control voltage from a particular photovoltaic array in the northern hemisphere versus time over a period from before sunrise to after sunset on a particular day, which photovoltaic array is controlled by a prior art maximum power point tracker. The effect of a shadow (caused in this case by a chimney place north-west of the array) is seen by a marked dip 124 in the voltage trace starting at around 17:25. The dip has a duration 125 of around 85 minutes.

In the inventive method, a sweep cycle will, in general, only be performed when there is a risk of a partial shadow. The controller 112 has therefore first to gain knowledge about the particular photovoltaic 103 system, and this knowledge must be daily updated to overcome seasonally variations.

In order to do this the day is divided into intervals. The length of these intervals may in principle be arbitrary, but typically an interval may be in the range 1 minute to 60 minutes, such as within the range 1 minute and 10 minutes, such as 5 minutes.

The data store 115 comprises a set of counters, each counter being assigned to one of the intervals into which the day is divided. For example, if the interval chosen in 5 minutes long, there are 12 such intervals in an hour and thus a total of 24×12 counters=288 counters are used in the data store 115. Alternatively, only a portion of the day, such as the interval between 06:00 in the morning and 18:00 in the afternoon, may be chosen.

An initial learning period is set. The length of this initial learning period may in principle be arbitrary, but typically a period may be in the range 1 day to 365 days, such as within the range 7 days to 90 days, such as 30 days.

All the counters which comprise the data store 115 are initially set to n, the number of days in the initial learning period. This is also the maximum value allowed in any counter. Alternatively, the counters may initially set to zero and count up to n, and the method as detailed below may be modified appropriately.

A sweep cycle is performed once during every interval. That is to say that is a sweep cycle is performed if and when the time elapsed since the last sweep cycle is equal or greater than the chosen interval. An analysis is performed to determine if there is more than a single peak in the power vs. Vi function obtained from set of power measurements made in the sweep cycle.

If there is only one peak, then the counter assigned to the current interval in the day is decremented by one. Thus, if there are no shadows detected in a particular interval, then the counter assigned to that interval will have reached zero after n days. When a counter has reached zero, sweep cycles are no longer performed in the interval to which it is assigned.

If there is more than one peak then the counter assigned to the current interval in the day is incremented by one. This ensures that a sweep cycle will also be performed in the interval on the following day. In addition, in order to detect a shadow as early on the day as possible, the counters assigned to the two adjacent intervals are also incremented by one.

The method of the current embodiment is shown in a flowchart form in FIG. 4.

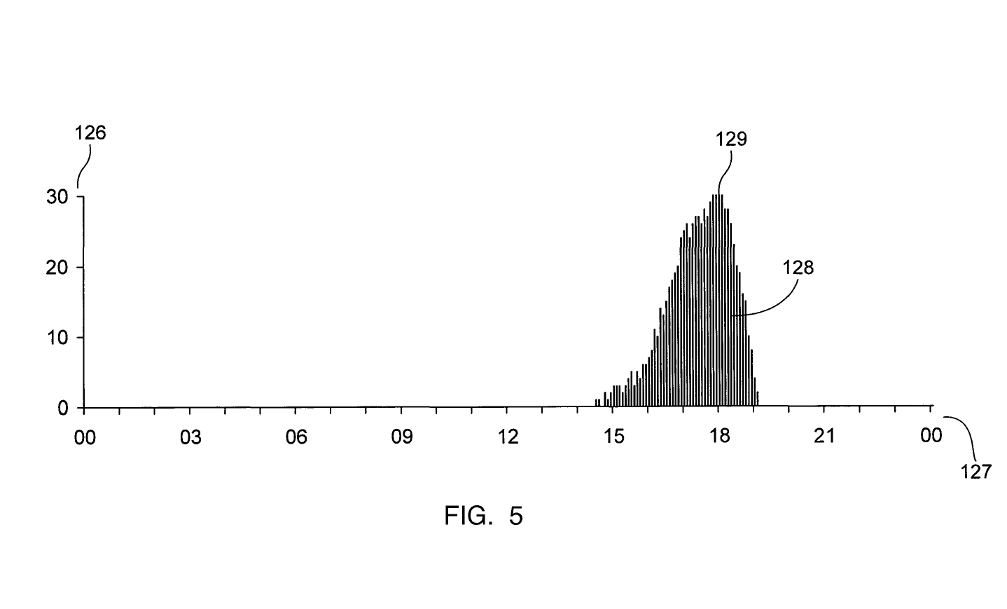

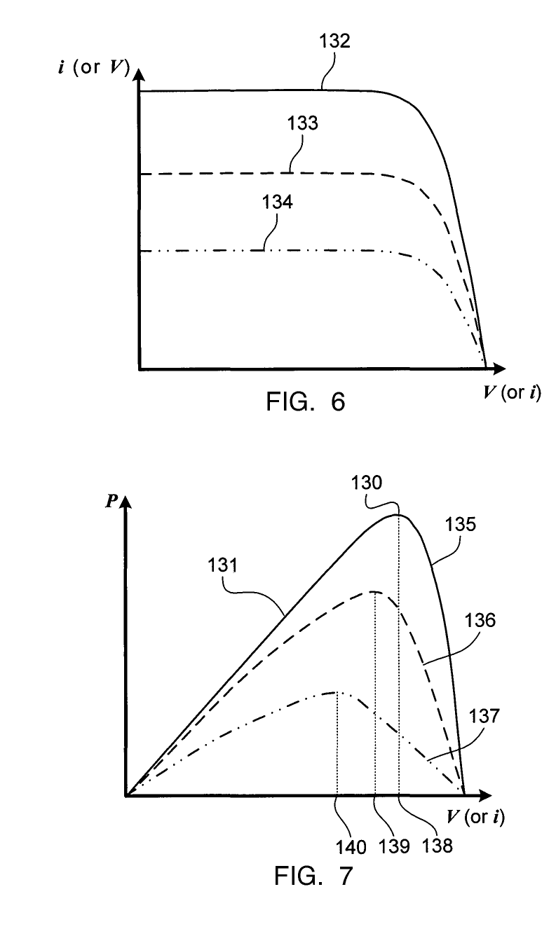

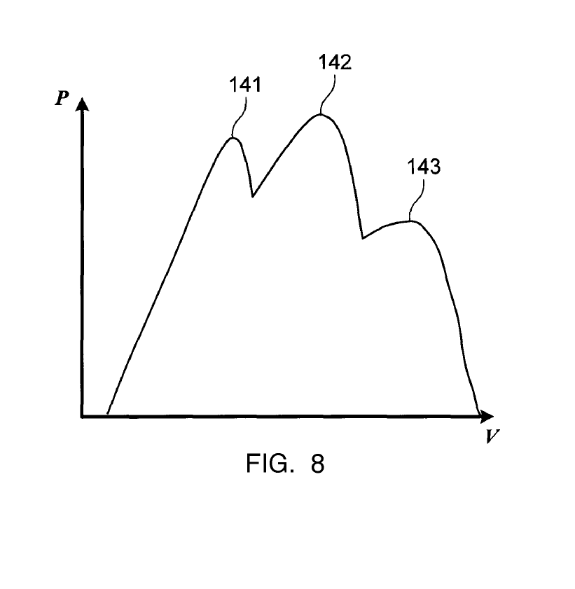

FIG. 5 shows the typical contents of the data store 115 for the photovoltaic array shown in FIG. 3. The contents 126 of each of the counters is plotted as a histogram against the time of day 127 assigned to each of the counters. We see that whilst most of the counters have decremented to zero, the counters assigned to times of day around 15-17 128 contain significant counts. The peak of this group occurs around 18:00, when several of the counters contain the maximum of 30 counts, showing that multi-peaked power vs. Vi function (and hence shadowing) occurs often at this time of day.

In order to detect shadows occurring at new times of day, the method may also include a random element where a certain number of sweep cycles are performed at random times during a day. This may be done by detecting whether there are any hours-long periods where all the assigned counters are set to zero, and incrementing a random counter within the hour-long period if that is true.

In addition, it is an advantage if certain characteristics of the operating parameter versus time signal also trigger the incrementing of counters. This could, for example, be sudden changes, such as the sudden increase in voltage at the end of the period 125 marked in FIG. 3.

A fourth embodiment of the invention will now be described. This embodiment can also be described by the schematic diagram shown in FIG. 2, wherein the power converter 102 is supplied with power from a photovoltaic array 103 subject to possible shadowing.

This embodiment makes use of a parameter calculated from the measurements made during sweep cycles. This parameter is known as a Peak Ratio (denoted k) and is calculated as:

$$k = \frac{{\sum }_{x = 1}^{n} {Vi}^{x} local}{\sum Vi global}$$

where n=number of peaks in the power measurements,
x=local peak number and
Vi^{x}local and Vi global are as defined below.

Thus, for a sweep cycle showing only a single peak, k=1, but for sweeps cycles with one or more subsidiary local peaks, k<1.

As described in the first embodiment, the controller 112 can operate in two modes, tracking and sweep cycle. During normal operation it runs in tracking mode, where it controls the setter 110 so that the voltage at the input 104 (Vi) is kept close to the maximum power point value of the operating value. As the maximum power point of the source 103 changes, the controller 12 follows this change.

In order to correct this, the controller is also able to operate in a sweep cycle mode in which may comprise the following steps:
a) Stop the tracking mode of operation.
b) Set Vi to a first value using the setter 110.
c) Measure the power generated by the power source using the power measuring system 111.
d) Repeat steps b) and c) with a different value of Vi until sufficient measurements of the power generated by the power source have been made in a selected range of Vi to enable the identification of the global maximum power point and any other local maximum power points which lie within the selected range.
e) Analyse the set of power measurements made in steps b) to d) to identify the value of Vi which corresponds to the global maximum power point. Let this value be denoted as Vi global.
f) Further analyse the set of power measurements to identify all the local maximum power points, these being denoted as Vi^{x}local, where x denotes the local peak number.
g) Calculate the ‘Peak Ratio’ (k) defined as:

$$k = \frac{{\sum }_{x = 1}^{n} {Vi}^{x} local}{\sum Vi global}$$

where n=number of peaks in the power measurements and
x=local peak number.
h) Store in the data store 115 the Peak Ratio obtained from set of power measurements made in steps b) to d).
i) Store in the data store 115 the time at which the sweep was performed, obtaining this data from the clock 113.
j) Recommence the tracking mode of operation with the initial value of Vi set to the global maximum power point value identified in step e).

On start-up, the MPPT 101 performs a sweep cycle at regular intervals. Such intervals may, for example, be once every hour, or once every 5 minutes. Gradually, a store of data will be accumulated comprising the Peak Ratio obtained from each individual sweep cycle performed, and the times at which those sweep cycles were performed. At a predetermined time after start-up, or after a predetermined number of sweep cycles have been performed, or in response to some other parameter, an analysis of the stored data is performed. This analysis detects correlations between the time of day (for example, the elapsed time since midnight) and the Peak Ratios obtained at those times. In the case of a photovoltaic array this is of particular interest, since low Peak Ratios occurring at around the same time of day are very likely to be caused by partial shadowing of a photovoltaic array 103.

Once it has been established in this way the time of day at which shadowing occurs, then the operation of the MPPT 101 is modified so that it preferentially performs sweeps cycles as these times of day. In this way the efficiency of the system is much improved, since fewer sweeps cycles will now be performed and so the loss of power outputted to the grid 106 will be reduced. That is to say, sweep cycles will only be performed when, from historical data, it is likely that shadowing of the photovoltaic array 103 is occurring.

Since seasonal variations in solar altitude will also influence the time at which shadowing occurs, it will still be an advantage to perform sweep cycles at other times of day, in order to keep the statistics up to date.

Although various embodiments of the present invention have been described and shown, the invention is not restricted thereto, but may also be embodied in other ways within the scope of the subject-matter defined in the following claims.

What is claimed is:

1-15. (canceled)

16. A method of operating a maximum power point tracker comprising the following steps:
performing a sweep cycle at intervals, the sweep cycle comprising the determination of at least one peak-related parameter of a power function;
storing the at least one first parameter and at least one time parameter; and
based on the data so stored, modifying one or more characteristics of the sweep cycles.

17. The method according to claim 16, wherein the modification of one or more characteristics of the sweep cycles is dependent upon at least one correlation between the stored peak-related parameters and time parameters.

18. The method according to claim 16, wherein the at least one time parameter is measured in connection with the sweep cycle.

19. The method according to claim 16, wherein the maximum power point tracker controls an operating parameter.

20. The method according to claim 19, wherein the characteristics of the sweep cycles comprise one or more of; the intervals between each sweep cycle, the range of operating parameter that a sweep cycle covers or the speed at which a sweep cycle is performed.

21. The method according to claim 16, wherein the power function is that of a power source.

22. The method according to claim 21, wherein the power function further comprises the relationship between the power available from the power source and the operating parameter.

23. The method according to claim 16, wherein the at least one peak-related parameter comprises the number of peaks in the power function.

24. The method according to claim 16, wherein the at least one peak-related parameter comprises the Peak Ratio calculated for the power function.

25. The method according to claim 16, wherein the at least one time parameter comprises the time at which the sweep cycle was performed.

26. The method according to claim 16, wherein the at least one time parameter comprises the time of day at which the sweep cycle was performed.

27. The method according to claim 16, wherein the operating parameter is a voltage or a current.

28. The method according to claim 16, wherein the modification comprises limiting the performance of sweep cycles substantially to times of day when the power function shows more than one peak.

29. A maximum power point tracking apparatus comprising a controller suitable for controlling an operating parameter, an input connected to a power source and a data store, which apparatus is suitable for being operated by the method claim 16.

30. The apparatus according to claim 29, wherein the operating parameter is a voltage or a current.
